(19) United States
(12) Patent Application Publication
(10) Pub. No.: US 2022/0046431 A1
(43) Pub. Date: Feb. 10, 2022

(54) CELL AND FULL DUPLEX BEAM PAIR UPDATING

(71) Applicant: QUALCOMM Incorporated, San Diego, CA (US)

(72) Inventors: Qian ZHANG, Basking Ridge, NJ (US); Yan ZHOU, San Diego, CA (US); Junyi LI, Fairless Hills, PA (US); Navid ABEDINI, Basking Ridge, NJ (US); Tao LUO, San Diego, CA (US)

(21) Appl. No.: 17/444,137

(22) Filed: Jul. 30, 2021

Related U.S. Application Data
(60) Provisional application No. 62/706,244, filed on Aug. 6, 2020.

(51) Int. Cl. H04W 16/28; H04B 7/06; H04L 5/14; H04L 5/00

(52) U.S. Cl. CPC H04W 16/28; H04L 5/001; H04L 5/14; H04B 7/0695

(57) ABSTRACT

Various aspects of the present disclosure generally relate to wireless communication. In some aspects, a user equipment (UE) may receive a message that includes: an indication of one or more selected cells associated with one or more component carriers, and an indication of one or more uplink and downlink beam pairs for full duplex operation. The UE may transmit an uplink communication and receive a downlink communication based at least in part on the message. Numerous other aspects are described.

### CROSS-REFERENCE TO RELATED APPLICATION

This patent application claims priority to Provisional Patent Application No. 62/706,244, filed on Aug. 6, 2020, entitled “JOINT CELL AND FULL DUPLEX BEAM UPDATING,” and assigned to the assignee hereof. The disclosure of the prior application is considered part of and is incorporated by reference in this patent application.

### FIELD OF THE DISCLOSURE

Aspects of the present disclosure generally relate to wireless communication and to techniques and apparatuses for cell and full duplex beam pair updating.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes: receiving a message that includes: an indication of one or more selected cells associated with one or more component carriers, and an indication of one or more uplink and downlink beam pairs for full duplex operation; and transmitting an uplink communication and receiving a downlink communication based at least in part on the message.

In some aspects, a method of wireless communication performed by a base station includes: transmitting, to a UE, a message that includes: an indication of one or more selected cells associated with one or more component carriers, and an indication of one or more uplink and downlink beam pairs for full duplex operation of the UE; and receiving an uplink communication and transmitting a downlink communication based at least in part on the message.

In some aspects, a UE for wireless communication includes a memory and one or more processors coupled to the memory, the one or more processors configured to: receive a message that includes: an indication of one or more selected cells associated with one or more component carriers, and an indication of one or more uplink and downlink beam pairs for full duplex operation; and transmit an uplink communication and receive a downlink communication based at least in part on the message.

In some aspects, a base station for wireless communication includes a memory and one or more processors coupled to the memory, the one or more processors configured to: transmit, to a UE, a message that includes: an indication of one or more selected cells associated with one or more component carriers, and an indication of one or more uplink and downlink beam pairs for full duplex operation of the UE; and receive an uplink communication and transmit a downlink communication based at least in part on the message.

In some aspects, a non-transitory computer-readable medium storing a set of instructions for wireless communication includes one or more instructions that, when executed by one or more processors of a UE, cause the UE to: receive a message that includes: an indication of one or more selected cells associated with one or more component carriers, and an indication of one or more uplink and downlink beam pairs for full duplex operation; and transmit an uplink communication and receive a downlink communication based at least in part on the message.

In some aspects, a non-transitory computer-readable medium storing a set of instructions for wireless communication includes one or more instructions that, when executed by one or more processors of a base station, cause the base station to: transmit, to a UE, a message that includes: an indication of one or more selected cells associated with one or more component carriers, and an indication of one or more uplink and downlink beam pairs for full duplex operation of the UE; and receive an uplink communication and transmit a downlink communication based at least in part on the message.

In some aspects, an apparatus for wireless communication includes: means for receiving a message that includes: an indication of one or more selected cells associated with one or more component carriers, and an indication of one or more uplink and downlink beam pairs for full duplex operation; and means for transmitting an uplink communication and receiving a downlink communication based at least in part on the message.

In some aspects, an apparatus for wireless communication includes: means for transmitting, to a UE, a message that includes: an indication of one or more selected cells associated with one or more component carriers, and an indication of one or more uplink and downlink beam pairs for full duplex operation of the UE; and means for receiving an uplink communication and transmitting a downlink communication based at least in part on the message.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of make-before-break handover, in accordance with the present disclosure.

FIG. 4 is a diagram illustrating an example associated with cell and full duplex beam pair updating, in accordance with the present disclosure.

FIGS. 5 and 6 are diagrams illustrating example processes associated with cell and full duplex beam pair updating, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

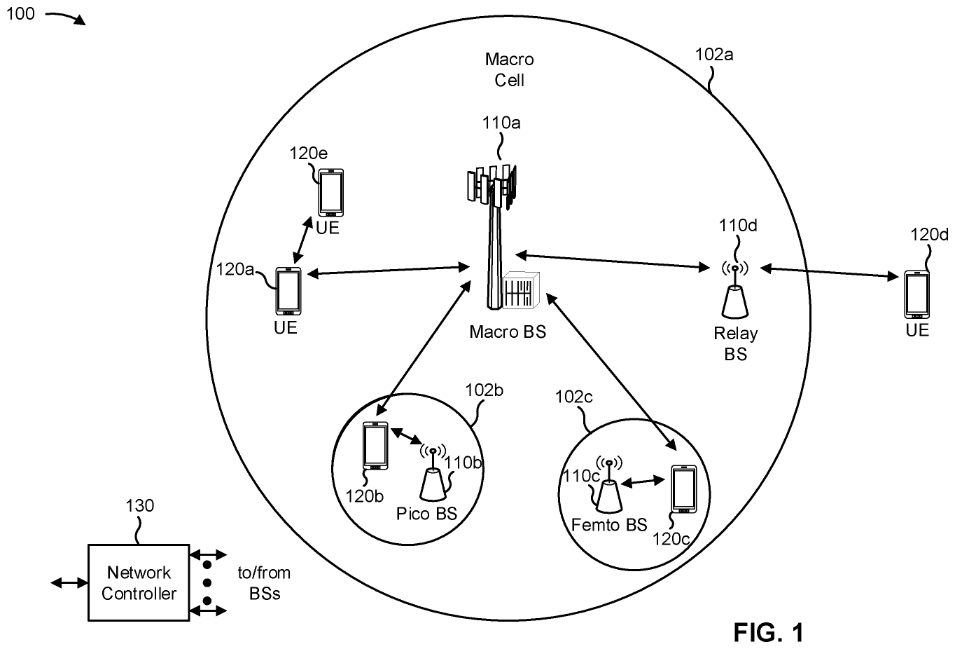

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. ABS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

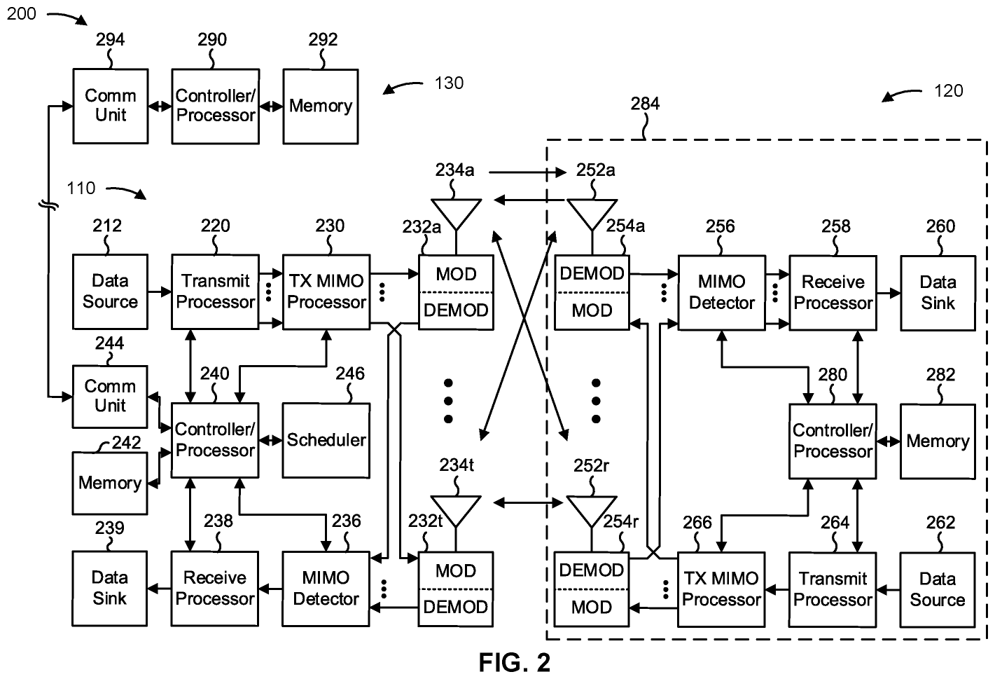

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

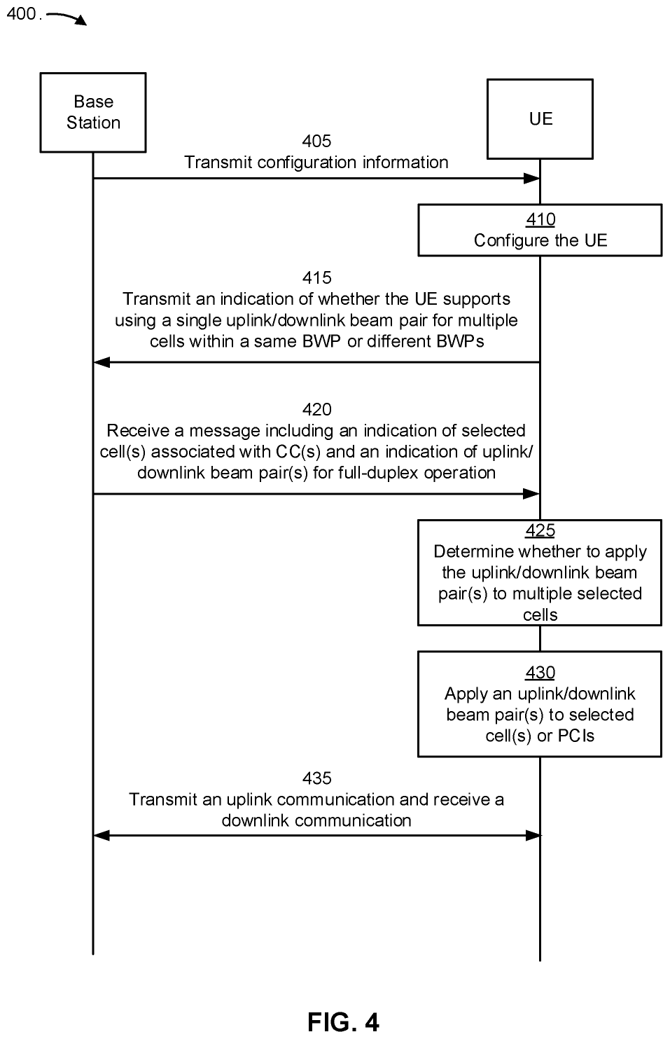

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-6).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-6).

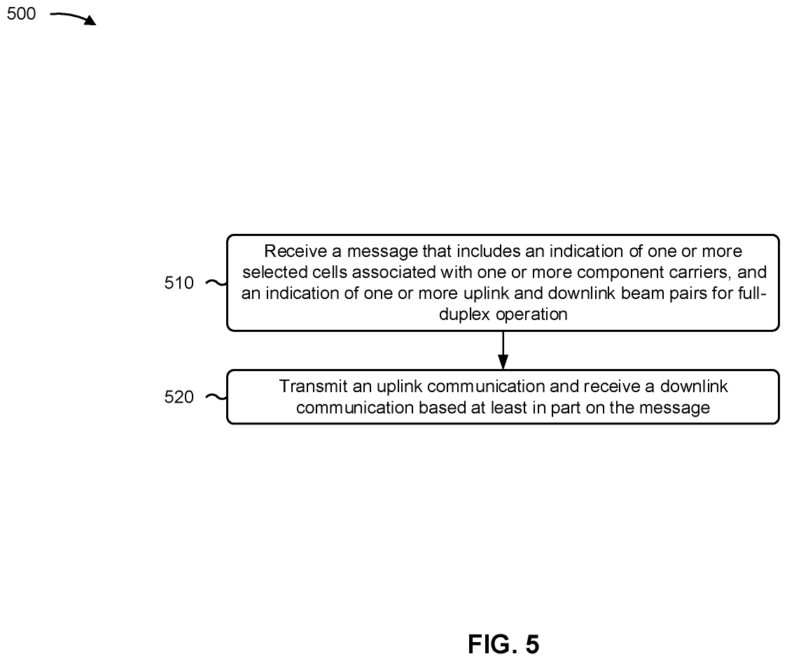

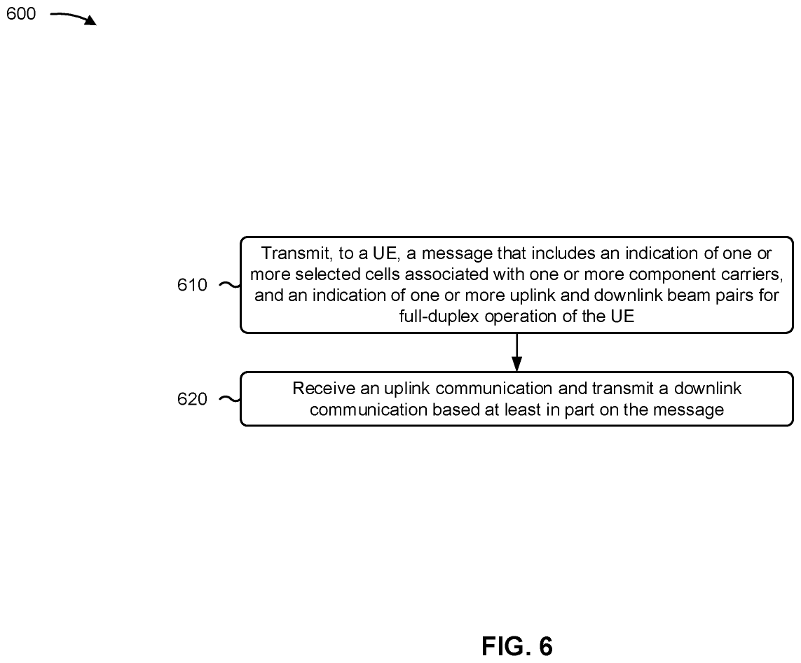

Controller/processor 240 of base station 110, controller/processor 280 of UE 120, and/or any other component(s) of FIG. 2 may perform one or more techniques associated with cell and full duplex beam pair updating, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, and/or interpreting the instructions, among other examples.

In some aspects, UE 120 may include means for receiving a message that includes an indication of one or more selected cells associated with one or more component carriers, and an indication of one or more uplink and downlink beam pairs for full duplex operation; means for transmitting an uplink communication and receiving a downlink communication based at least in part on the message; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting, to a UE, a message that includes an indication of one or more selected cells associated with one or more component carriers, and an indication of one or more uplink and downlink beam pairs for full duplex operation of the UE; means for receiving an uplink communication and transmitting a downlink communication based at least in part on the message; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

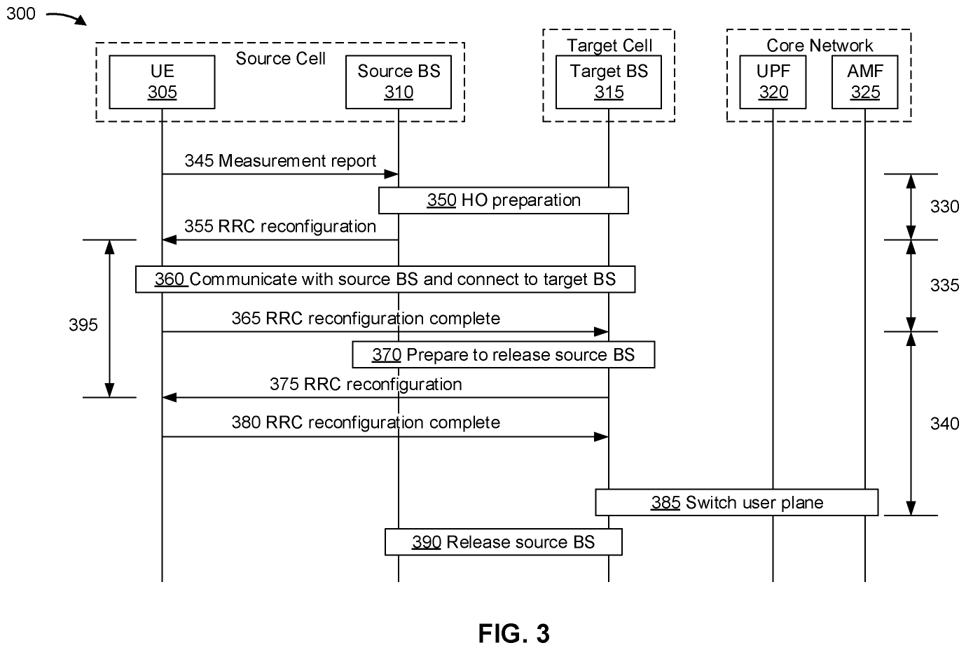

FIG. 3 is a diagram illustrating an example 300 of make-before-break handover, in accordance with the present disclosure.

As shown in FIG. 3, a make-before-break (MBB) handover procedure may involve a UE 305, a source base station 310, a target base station 315, a user plane function (UPF) device 320, and an access and mobility management function (AMF) device 325. The UE 305 may correspond to the UE 120 described elsewhere herein. The source base station 310 and/or the target base station 315 may correspond to the base station 110 described elsewhere herein. The UPF device 320 and/or the AMF device 325 may correspond to the network controller 130 described elsewhere herein. The UE 305 and the source base station 310 may be connected (e.g., may have a radio resource control (RRC) connection) via a serving cell or a source cell, and the UE 305 may undergo a handover to the target base station 315 via a target cell. The UPF device 320 and/or the AMF device 325 may be located within a core network. The source base station 310 and the target base station 315 may be in communication with the core network for mobility support and user plane functions. The MBB handover procedure may include an enhanced MBB (eMBB) handover procedure.

As shown, the MBB handover procedure may include a handover preparation phase 330, a handover execution phase 335, and a handover completion phase 340. During the handover preparation phase 330, the UE 305 may report measurements that cause the source base station 310 and/or the target base station 315 to prepare for handover and trigger execution of the handover. During the handover execution phase 335, the UE 305 may execute the handover by performing a random access procedure with the target base station 315 and establishing an RRC connection with the target base station 315. During the handover completion phase 340, the source base station 310 may forward stored communications associated with the UE 305 to the target base station 315, and the UE 305 may be released from a connection with the source base station 310.

As shown by reference number 345, the UE 305 may perform one or more measurements, and may transmit a measurement report to the source base station 310 based at least in part on performing the one or more measurements (e.g., serving cell measurements, neighbor cell measurements, and/or the like). The measurement report may indicate, for example, an RSRP parameter, an RSRQ parameter, an RSSI parameter, a signal-to-interference-plus-noise-ratio (SINR) parameter, and/or the like (e.g., for the serving cell, one or more neighbor cells, and/or the like). The source base station 310 may use the measurement report to determine whether to trigger a handover to the target base station 315. For example, if one or more measurements satisfy a condition, then the source base station 310 may trigger a handover of the UE 305 to the target base station 315.

As shown by reference number 350, the source base station 310 and the target base station 315 may communicate with one another to prepare for a handover of the UE 305. As part of the handover preparation, the source base station 310 may transmit a handover request to the target base station 315 to instruct the target base station 315 to prepare for the handover. The source base station 310 may communicate RRC context information associated with the UE 305 and/or configuration information associated with the UE 305 to the target base station 315. The target base station 315 may prepare for the handover by reserving resources for the UE 305. After reserving the resources, the target base station 315 may transmit an acknowledgement (ACK) to the source base station 310 in response to the handover request.

As shown by reference number 355, the source base station 310 may transmit an RRC reconfiguration message to the UE 305. The RRC reconfiguration message may include a handover command instructing the UE 305 to execute a handover procedure from the source base station 310 to the target base station 315. The handover command may include information associated with the target base station 315, such as a random access channel (RACH) preamble assignment for accessing the target base station 315. Reception of the RRC reconfiguration message, including the handover command, by the UE 305 may trigger the start of the handover execution phase 335.

As shown by reference number 360, during the handover execution phase 335 of the MBB handover, the UE 305 may execute the handover by performing a random access procedure with the target base station 315 (e.g., including synchronization with the target base station 315) while continuing to communicate with the source base station 310. For example, while the UE 305 is performing the random access procedure with the target base station 315, the UE 305 may transmit uplink data, uplink control information, an uplink reference signal (e.g., a sounding reference signal), and/or the like to the source base station 310, and/or may receive downlink data, downlink control information, a downlink reference signal, and/or the like from the source base station 310.

As shown by reference number 365, upon successfully establishing a connection with the target base station 315 (e.g., via a random access procedure), the UE may transmit an RRC reconfiguration completion message to the target base station 315. Reception of the RRC reconfiguration message by the target base station 315 may trigger the start of the handover completion phase 340.

As shown by reference number 370, the source base station 310 and the target base station 315 may communicate with one another to prepare for release of the connection between the source base station 310 and the UE 305. In some aspects, the target base station 315 may determine that a connection between the source base station 310 and the UE 305 is to be released, such as after receiving the RRC reconfiguration message from the UE 305. In this case, the target base station 315 may transmit a handover connection setup completion message to the source base station 310. The handover connection setup completion message may cause the source base station 310 to stop transmitting data to the UE 305 and/or to stop receiving data from the UE 305. Additionally, or alternatively, the handover connection setup completion message may cause the source base station 310 to forward communications associated with the UE 305 to the target base station 315 and/or to notify the target base station 315 of a status of one or more communications with the UE 305. For example, the source base station 310 may forward, to the target base station 315, buffered downlink communications (e.g., downlink data) for the UE 305 and/or uplink communications (e.g., uplink data) received from the UE 305. Additionally, or alternatively, the source base station 310 may notify the target base station 315 regarding a packet data convergence protocol (PDCP) status associated with the UE 305, a sequence number to be used for a downlink communication with the UE 305, and/or the like.

As shown by reference number 375, the target base station 315 may transmit an RRC reconfiguration message to the UE 305 to instruct the UE 305 to release the connection with the source base station 310. Upon receiving the instruction to release the connection with the source base station 310, the UE 305 may stop communicating with the source base station 310. For example, the UE 305 may refrain from transmitting uplink communications to the source base station 310 and/or may refrain from monitoring for downlink communications from the source base station 310.

As shown by reference number 380, the UE may transmit an RRC reconfiguration completion message to the target base station 315 to indicate that the connection between the source base station 310 and the UE 305 is being released or has been released.

As shown by reference number 385, the target base station 315, the UPF device 320, and/or the AMF device 325 may communicate to switch a user plane path of the UE 305 from the source base station 310 to the target base station 315. Prior to switching the user plane path, downlink communications for the UE 305 may be routed through the core network to the source base station 310. After the user plane path is switched, downlink communications for the UE 305 may be routed through the core network to the target base station 315. Upon completing the switch of the user plane path, the AMF device 325 may transmit an end marker message to the source base station 310 to signal completion of the user plane path switch. As shown by reference number 390, the target base station 315 and the source base station 310 may communicate to release the source base station 310.

As part of the MBB handover procedure, the UE 305 may maintain simultaneous connections with the source base station 310 and the target base station 315 during a time period 395. The time period 395 may start at the beginning of the handover execution phase 335 (e.g., upon reception by the UE 305 of a handover command from the source base station 310) when the UE 305 performs a random access procedure with the target base station 315. The time period 395 may end upon release of the connection between the UE 305 and the source base station 310 (e.g., upon reception by the UE 305 of an instruction, from the target base station 315, to release the source base station 310). By maintaining simultaneous connections with the source base station 310 and the target base station 315, the handover procedure can be performed with zero or a minimal interruption to communications, thereby reducing latency.

As indicated above, FIG. 3 is provided as an example. Other examples may differ from what is described with respect to FIG. 3.

In some wireless networks, a network may support layer 1 and/or layer 2 centric (e.g., L1/L2-centric) inter-cell mobility for UEs to select one or more cells (e.g., for a handover process). A UE may receive a first indication, via a first message (e.g., a downlink control information (DCI) message or a medium access control (MAC) control element (MAC-CE)) of a selected cell for subsequent communications with, for example, a base station. After receiving the first indication, the UE may receive a second indication, via a second message, of an uplink beam and a downlink beam to use for the subsequent communications. Based at least in part on receiving the first indication and the second indication via multiple messages, the UE and the base station may consume power, communication, processing, and network resources.

In some aspects described herein, a UE may receive a message that indicates one or more selected cells associated with one or more component carriers and indicates one or more uplink and downlink beam pairs for full duplex operation. In other words, the message (e.g., a DCI or MAC-CE message) may jointly indicate a selected cell and an uplink and downlink beam pair.

In some aspects, the message may indicate an identity of the one or more selected cells using, for example, a physical cell identification, a serving cell identification, and/or the like. In some aspects, the message may additionally indicate at least one uplink and downlink beam pair to be used per cell. For example, for a control channel, the message may indicate an uplink and downlink beam pair using an activated transmission configuration indicator (TCI) state identification that indicates an uplink direction for a first beam and a downlink direction for a second beam, per control resource set (CORESET) identification. For a shared channel, the message may indicate an uplink and downlink beam pair using an activated TCI state identification that indicates an uplink direction for a first beam and a downlink direction for a second beam. Similarly, for other types of uplink and downlink communications (e.g., downlink reference signals, uplink reference signals, random access channels, and/or the like), the message may indicate an uplink and downlink beam pair using an activated TCI state identification that indicates an uplink direction for a first beam and a downlink direction for a second beam.

In some aspects, the message may indicate that the one or more uplink and downlink beam pairs are to be applied to multiple selected cells of the one or more selected cells. For example, the message may indicate a selected cell to use the one or more uplink and downlink beam pairs, and the selected cell may be associated with the multiple selected cells (e.g., via a pre-configured list of cells). In some aspects, the message may indicate a list of the multiple selected cells to use the one or more uplink and downlink beam pairs, may indicate the multiple selected cells via a cell group identification, and/or the like. In some aspects, the message may separately indicate an uplink and downlink beam pair to be used per each of the multiple selected cells.

In some aspects, the message may indicate that the one or more uplink and downlink beam pairs are to be applied to one or more component carriers. In the case of L1/L2 inter-cell mobility and carrier aggregation, each uplink and downlink pair may also be indicated to be used across multiple component carriers in carrier aggregation. In the case of L1/L2 inter-cell mobility and dual connectivity, each uplink and downlink pair may also be indicated to be used across multiple component carriers in a cell group, such as a master cell group, a secondary cell group, and/or the like.

Based at least in part on the UE receiving a single message that indicates one or more selected cells associated with one or more component carriers and indicates one or more uplink and downlink pairs to use with the one or more selected cells in full duplex operation, the UE and base station may conserve computing, communication, network, and/or power resources.

FIG. 4 is a diagram illustrating an example 400 of cell and full duplex beam pair updating, in accordance with the present disclosure. As shown in FIG. 4, a UE (e.g., UE 120) may communicate (e.g., transmit an uplink transmission and/or receive a downlink transmission) with a base station (e.g., base station 110) as part of a cell selection process. The UE and the base station may be part of a wireless network (e.g., wireless network 100).

As shown by reference number 405, the base station may transmit, and the UE may receive, configuration information. In some aspects, the UE may receive configuration information from another device (e.g., from another base station, another UE, and/or the like), a communication standard, and/or the like. In some aspects, the UE may receive the configuration information via one or more of RRC signaling, MAC signaling (e.g., MAC CEs), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to receive a message that includes an indication of one or more selected cells associated with one or more component carriers, and an indication of one or more uplink and downlink beam pairs for full duplex operation. In some aspects, the configuration information may indicate that the UE is to transmit an indication of whether the UE supports using a single uplink/downlink beam pair for multiple cells within a same bandwidth part (BWP) or different BWPs.

As shown by reference number 410, the UE may configure the UE for communicating with the base station. In some aspects, the UE may configure the UE based at least in part on the configuration information. In some aspects, the UE may be configured to perform one or more operations described herein.

As shown by reference number 415, the UE may transmit, and the base station may receive, an indication of whether the UE supports using a single uplink/downlink beam pair for multiple cells within a same BWP or different BWPs. In some aspects, the UE may transmit the indication via RRC signaling, one or more MAC-CEs, a physical uplink control channel (PUCCH) message, and/or the like.

As shown by reference number 420, the UE may receive a message including an indication of one or more selected cells associated with one or more component carriers and an indication of one or more uplink and downlink beam pairs for full duplex operation of the UE. In some aspects, the message may be a single message, such as a DCI message, a message that includes one or more MAC-CEs, and/or the like.

In some aspects, the indication of the one or more selected cells may include a physical cell identification (PCI), a serving cell identification, and/or the like.

In some aspects, the indication of the one or more uplink and downlink beam pairs may include an indication of at least one downlink and uplink beam pair to use for each of the one or more selected cells. In some aspects, the indication of the one or more uplink and downlink beam pairs may include an indication of at least one downlink and uplink beam pair to use for multiple cells of the one or more selected cells. In some aspects, the indication of the at least one downlink and uplink pair may include at least one TCI state identification that indicates an uplink direction for a first beam and a downlink direction for a second beam. For example, the at least one TCI state identification may identify the first beam using an uplink reference signal identification and may identify the second beam using a downlink reference signal identification.

In some aspects, the first beam may be associated with an uplink shared channel (e.g., physical uplink shared channel), an uplink reference signal (e.g., a sounding reference signal), a physical random access channel, and/or the like. In some aspects, the second beam may be associated with a downlink shared channel (e.g., a physical downlink shared channel), a downlink reference signal (e.g., a channel state information reference signal), a CORESET, and/or the like.

In some aspects, the indication of the one or more uplink and downlink beam pairs includes an indication of at least one downlink and uplink beam pair to use for multiple component carriers of the one or more component carriers. For example, the indication may include an indication of a cell group, that includes the multiple component carriers, to use the at least one downlink and uplink beam pair. In some aspects, the cell group may be a master cell group or a secondary cell group. In some aspects, the indication may include an indication of a set of aggregated component carriers, that includes the multiple component carriers, to use the uplink and downlink beam pair.

As shown by reference number 425, the UE may determine whether to apply the uplink and downlink beam pair to multiple selected cells (or multiple PCIs). In some aspects, the UE may determine to apply the uplink and downlink beam pair to multiple selected cells based at least in part on the multiple cells being associated with a cell indicated within the message. For example, the multiple cells may be associated via a cell list (e.g., a preconfigured cell list based at least in part on pre-configured information at the UE). In some aspects, the UE may determine to apply the uplink and downlink beam pair to multiple selected cells based at least in part on the message identifying the multiple selected cells or multiple PCIs to use the uplink and downlink beam pair. In some aspects, the UE may determine to apply the uplink and downlink beam pair to multiple selected cells based at least in part on the message indicating to use the one or more uplink and downlink beam pairs for all selected cells or PCIs per cell group.

In some aspects, the UE may determine that the message indicates a first selected cell or PCI to use the uplink and downlink beam pair and indicates a second selected cell or PCI to use another uplink and downlink beam pair. In some aspects, the UE may determine, based at least in part on frequencies of the multiple selected cells, that the UE supports using the uplink and downlink beam pair for the multiple selected cells that have a same bandwidth part and/or for the multiple selected cells that have different bandwidth parts.

As shown by reference number 430, the UE may apply the one or more uplink and downlink beam pairs to the one or more selected cells or PCIs. In some aspects, the UE may configure the UE to use the one or more uplink and downlink beam pairs for communications via the one or more selected cells. For example, the UE may configure the UE to use a first uplink and downlink beam pair for communications via a first set of the one or more selected cells, to use a second uplink and downlink beam pair for communications via a second set of the one or more selected cells, and/or the like.

As shown by reference number 435, the UE may transmit an uplink communication and receive a downlink communication based at least in part on the message. For example, the UE and the base station may communicate via the one or more selected cells using the one or more uplink and downlink beam pairs.

Based at least in part on the UE receiving the message as a single message that indicates one or more selected cells associated with one or more component carriers and indicates one or more uplink and downlink pairs to use with the one or more selected cells in full duplex operation, the UE and base station may conserve computing, communication, network, and/or power resources.

As indicated above, FIG. 4 is provided as an example. Other examples may differ from what is described with regard to FIG. 4. For example, operations shown in FIG. 4 may be performed in a different order, some operations may be omitted, additional operations may be added, some operations may be combined, and/or the like.

FIG. 5 is a diagram illustrating an example process 500 of cell and full duplex beam pair updating, in accordance with the present disclosure. Other examples may differ from

As shown in FIG. 5, in some aspects, process 500 may include receiving a message that includes an indication of one or more selected cells associated with one or more component carriers, and an indication of one or more uplink and downlink beam pairs for full duplex operation (block 510). For example, the UE (e.g., using antenna 252, demodulator 254, MIMO detector 256, receive processor 258, controller/processor 280, and/or memory 282) may receive a message that includes an indication of one or more selected cells associated with one or more component carriers, and an indication of one or more uplink and downlink beam pairs for full duplex operation, as described above.

As further shown in FIG. 5, in some aspects, process 500 may include transmitting an uplink communication and receiving a downlink communication based at least in part on the message (block 520). For example, the UE (e.g., using antenna 252, transmit processor 264, TX MIMO processor 266, modulator 254, controller/processor 280, and/or memory 282) may transmit an uplink communication and receive a downlink communication based at least in part on the message, as described above.

Process 500 may include additional aspects, such as any single aspect or any combination of aspects described below and/or in connection with one or more other processes described elsewhere herein.

In a first aspect, the indication of the one or more selected cells includes one or more of a physical cell identification, or a serving cell identification.

In a second aspect, alone or in combination with the first aspect, the indication of the one or more uplink and downlink beam pairs for full duplex operation includes an indication of at least one downlink and uplink beam pair to use for each of the one or more selected cells.

In a third aspect, alone or in combination with one or more of the first and second aspects, the indication of the at least one downlink and uplink beam pair includes at least one TCI state identification that indicates an uplink direction for a first beam and a downlink direction for a second beam.

In a fourth aspect, alone or in combination with one or more of the first through third aspects, the first beam is associated with one or more of an uplink shared channel, an uplink reference signal, or a physical random access channel.

In a fifth aspect, alone or in combination with one or more of the first through fourth aspects, the second beam is associated with one or more of a control resource set identification, a downlink shared channel, or a downlink reference signal.

In a sixth aspect, alone or in combination with one or more of the first through fifth aspects, transmitting the uplink communication and receiving the downlink communication includes applying an uplink and downlink beam pair, of the one or more uplink and downlink beam pairs, to multiple selected cells of the one or more selected cells or multiple physical cell identifications.

In a seventh aspect, alone or in combination with one or more of the first through sixth aspects, applying the uplink and downlink beam pair to the multiple selected cells includes determining that the message indicates a first selected cell or physical cell identification to use the uplink and downlink beam pair; determining, based at least in part on pre-configured information at the UE, that the first selected cell or physical cell identification is associated with a second selected cell or physical cell identification; and determining, based at least in part on the first selected cell or physical cell identification being associated with the second selected cell or physical cell identification, to apply the uplink and downlink beam pair to the first selected cell or physical cell identification and the second selected cell or physical cell identification.

In an eighth aspect, alone or in combination with one or more of the first through seventh aspects, applying the uplink and downlink beam pair to the multiple selected cells includes determining that the message indicates a first selected cell or physical cell identification and a second selected cell or physical cell identification to use the uplink and downlink beam pair, or determining that the message indicates that all selected cells or physical cell identifications per cell group are to use the uplink and downlink beam pair.

In a ninth aspect, alone or in combination with one or more of the first through eighth aspects, applying the uplink and downlink beam pair to the multiple selected cells includes determining that the message indicates a first selected cell or physical cell identification to use the uplink and downlink beam pair and indicates a second selected cell or physical cell identification to use another uplink and downlink beam pair.

In a tenth aspect, alone or in combination with one or more of the first through ninth aspects, applying the uplink and downlink beam pair to the multiple selected cells includes determining, based at least in part on frequencies of the multiple selected cells, that the UE supports using the uplink and downlink beam pair for the multiple selected cells that have a same bandwidth part.

In an eleventh aspect, alone or in combination with one or more of the first through tenth aspects, applying the uplink and downlink beam pair to the multiple selected cells includes determining, based at least in part on frequencies of the multiple selected cells, that the UE supports using the uplink and downlink beam pair for the multiple selected cells that have different bandwidth parts.

In a twelfth aspect, alone or in combination with one or more of the first through eleventh aspects, the indication of the one or more uplink and downlink beam pairs for full duplex operation includes an indication of at least one downlink and uplink beam pair to use for multiple component carriers of the one or more component carriers.

In a thirteenth aspect, alone or in combination with one or more of the first through twelfth aspects, the indication of the at least one downlink and uplink beam pair to use for the multiple component carriers includes an indication of a cell group, that includes the multiple component carriers, to use the at least one downlink and uplink beam pair, wherein the cell group is a master cell group or a secondary cell group.

In a fourteenth aspect, alone or in combination with one or more of the first through thirteenth aspects, the indication of the at least one downlink beam and the at least one uplink beam to use for the multiple component carriers includes an indication of a set of aggregated component carriers, that includes the multiple component carriers, to use the uplink and downlink beam pair.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with cell and full duplex beam pair updating.

As shown in FIG. 6, in some aspects, process 600 may include transmitting, to a UE, a message that includes an indication of one or more selected cells associated with one or more component carriers, and an indication of one or more uplink and downlink beam pairs for full duplex operation of the UE (block 610). For example, the base station (e.g., using transmit processor 220, TX MIMO processor 230, modulator 232, antenna 234, controller/processor 240, memory 242, and/or scheduler 246) may transmit, to a UE, a message that includes: an indication of one or more selected cells associated with one or more component carriers, and an indication of one or more uplink and downlink beam pairs for full duplex operation of the UE, as described above.

As further shown in FIG. 6, in some aspects, process 600 may include receiving an uplink communication and transmitting a downlink communication based at least in part on the message (block 620). For example, the base station (e.g., using antenna 234, demodulator 232, MIMO detector 236, receive processor 238, controller/processor 240, and/or memory 242) may receive an uplink communication and transmit a downlink communication based at least in part on the message, as described above.

Process 600 may include additional aspects, such as any single aspect or any combination of aspects described below and/or in connection with one or more other processes described elsewhere herein.

In a first aspect, the indication of the one or more selected cells includes one or more of a physical cell identification, or a serving cell identification.

In a second aspect, alone or in combination with the first aspect, the indication of the one or more uplink and downlink beam pairs for full duplex operation of the UE includes an indication of at least one downlink and uplink beam pair to use for each of the one or more selected cells.

In a third aspect, alone or in combination with one or more of the first and second aspects, the indication of the at least one downlink and uplink beam pair includes at least one TCI state identification that indicates an uplink direction for a first beam and a downlink direction for a second beam.

In a fourth aspect, alone or in combination with one or more of the first through third aspects, the first beam is associated with one or more of an uplink shared channel, an uplink reference signal, or a physical random access channel.

In a fifth aspect, alone or in combination with one or more of the first through fourth aspects, the second beam is associated with one or more of a control resource set identification, a downlink shared channel, or a downlink reference signal.

In a sixth aspect, alone or in combination with one or more of the first through fifth aspects, the message includes an indication to apply an uplink and downlink beam pair, of the one or more uplink and downlink beam pairs, to multiple selected cells of the one or more selected cells or multiple physical cell identifications.

In a seventh aspect, alone or in combination with one or more of the first through sixth aspects, the indication to apply the uplink and downlink beam pair to the multiple selected cells includes an indication of a first selected cell or physical cell identification to use the uplink and downlink beam pair, wherein, based at least in part on pre-configured information at the UE, the first selected cell or physical cell identification is associated with a second selected cell or physical cell identification.

In an eighth aspect, alone or in combination with one or more of the first through seventh aspects, the indication to apply the uplink and downlink beam pair to the multiple selected cells includes an indication of a first selected cell or physical cell identification and a second selected cell or physical cell identification to use the uplink and downlink beam pair, or an indication that all selected cells or physical cell identifications per cell group are to use the uplink and downlink beam pair.

In a ninth aspect, alone or in combination with one or more of the first through eighth aspects, the indication to apply the uplink and downlink beam pair to the multiple selected cells includes an indication of a first selected cell or physical cell identification to use the uplink and downlink beam pair, and an indication of a second selected cell or physical cell identification to use another uplink and downlink beam pair.

In a tenth aspect, alone or in combination with one or more of the first through ninth aspects, process 600 includes receiving an indication, based at least in part on frequencies of the multiple selected cells, that the UE supports using a single uplink and downlink beam pair for the multiple selected cells that have a same bandwidth part.

In an eleventh aspect, alone or in combination with one or more of the first through tenth aspects, process 600 includes receiving an indication, based at least in part on frequencies of the multiple selected cells, that the UE supports using a single uplink and downlink beam pair for the multiple selected cells that have different bandwidth parts.

In a twelfth aspect, alone or in combination with one or more of the first through eleventh aspects, the indication of the one or more uplink and downlink beam pairs for full duplex operation includes an indication of at least one downlink and uplink beam pair to use for multiple component carriers of the one or more component carriers.

In a thirteenth aspect, alone or in combination with one or more of the first through twelfth aspects, the indication of the at least one downlink and uplink beam pair to use for the multiple component carriers includes an indication of a cell group, that includes the multiple component carriers, to use the at least one downlink and uplink beam pair, wherein the cell group is a master cell group or a secondary cell group.

In a fourteenth aspect, alone or in combination with one or more of the first through thirteenth aspects, the indication of the at least one downlink beam and the at least one uplink beam to use for the multiple component carriers includes an indication of a set of aggregated component carriers, that includes the multiple component carriers, to use the uplink and downlink beam pair.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: A method of wireless communication performed by a user equipment (UE), comprising: receiving a message that includes: an indication of one or more selected cells associated with one or more component carriers, and an indication of one or more uplink and downlink beam pairs for full duplex operation; and transmitting an uplink communication and receiving a downlink communication based at least in part on the message.

Aspect 2: The method of Aspect 1, wherein the indication of the one or more selected cells includes one or more of: a physical cell identification, or a serving cell identification.

Aspect 3: The method of any of Aspects 1 or 2, wherein the indication of the one or more uplink and downlink beam pairs for full duplex operation comprises: an indication of at least one downlink and uplink beam pair to use for each of the one or more selected cells.

Aspect 4: The method of Aspect 3, wherein the indication of the at least one downlink and uplink beam pair comprises: at least one transmission configuration indicator (TCI) state identification that indicates an uplink direction for a first beam and a downlink direction for a second beam.

Aspect 5: The method of Aspect 4, wherein the first beam is associated with one or more of: an uplink shared channel, an uplink reference signal, or a physical random access channel.

Aspect 6: The method of any of Aspects 4 or 5, wherein the second beam is associated with one or more of: a control resource set identification, a downlink shared channel, or a downlink reference signal.

Aspect 7: The method of any of Aspects 1-6, wherein transmitting the uplink communication and receiving the downlink communication comprises: applying an uplink and downlink beam pair, of the one or more uplink and downlink beam pairs, to multiple selected cells of the one or more selected cells or multiple physical cell identifications.

Aspect 8: The method of Aspect 7, wherein applying the uplink and downlink beam pair to the multiple selected cells comprises: determining that the message indicates a first selected cell or physical cell identification to use the uplink and downlink beam pair, determining, based at least in part on pre-configured information at the UE, that the first selected cell or physical cell identification is associated with a second selected cell or physical cell identification, and determining, based at least in part on the first selected cell or physical cell identification being associated with the second selected cell or physical cell identification, to apply the uplink and downlink beam pair to the first selected cell or physical cell identification and the second selected cell or physical cell identification.

Aspect 9: The method of Aspect 7, wherein applying the uplink and downlink beam pair to the multiple selected cells comprises: determining that the message indicates a first selected cell or physical cell identification and a second selected cell or physical cell identification to use the uplink and downlink beam pair, or determining that the message indicates all selected cells or physical cell identifications per cell group are to use the uplink and downlink beam pair.

Aspect 10: The method of Aspect 7, wherein applying the uplink and downlink beam pair to the multiple selected cells comprises: determining that the message indicates a first selected cell or physical cell identification to use the uplink and downlink beam pair and indicates a second selected cell or physical cell identification to use another uplink and downlink beam pair.

Aspect 11: The method of Aspect 7, wherein applying the uplink and downlink beam pair to the multiple selected cells comprises: determining, based at least in part on frequencies of the multiple selected cells, that the UE supports using the uplink and downlink beam pair for the multiple selected cells that have a same bandwidth part.

Aspect 12: The method of any of Aspects 1-10, wherein applying the uplink and downlink beam pair to the multiple selected cells comprises: determining, based at least in part on frequencies of the multiple selected cells, that the UE supports using the uplink and downlink beam pair for the multiple selected cells that have different bandwidth parts.

Aspect 13: The method of any of Aspects 1-12, wherein the indication of the one or more uplink and downlink beam pairs for full duplex operation comprises: an indication of at least one downlink and uplink beam pair to use for multiple component carriers of the one or more component carriers.

Aspect 14: The method of Aspect 13, wherein the indication of the at least one downlink and uplink beam pair to use for the multiple component carriers comprises: an indication of a cell group, that includes the multiple component carriers, to use the at least one downlink and uplink beam pair, wherein the cell group is a master cell group or a secondary cell group.

Aspect 15: The method of Aspect 13, wherein the indication of the at least one downlink beam and the at least one uplink beam to use for the multiple component carriers comprises: an indication of a set of aggregated component carriers, that includes the multiple component carriers, to use the uplink and downlink beam pair.

Aspect 16: A method of wireless communication performed by a base station, comprising: transmitting, to a user equipment (UE), a message that includes: an indication of one or more selected cells associated with one or more component carriers, and an indication of one or more uplink and downlink beam pairs for full duplex operation of the UE; and receiving an uplink communication and transmitting a downlink communication based at least in part on the message.

Aspect 17: The method of Aspect 16, wherein the indication of the one or more selected cells includes one or more of: a physical cell identification, or a serving cell identification.

Aspect 18: The method of any of Aspects 16 or 17, wherein the indication of the one or more uplink and downlink beam pairs for full duplex operation of the UE comprises: an indication of at least one downlink and uplink beam pair to use for each of the one or more selected cells.

Aspect 19: The method of Aspect 18, wherein the indication of the at least one downlink and uplink beam pair comprises: at least one transmission configuration indicator (TCI) state identification that indicates an uplink direction for a first beam and a downlink direction for a second beam.

Aspect 20: The method of Aspect 19, wherein the first beam is associated with one or more of: an uplink shared channel, an uplink reference signal, or a physical random access channel.

Aspect 21: The method of any of Aspects 19 or 20, wherein the second beam is associated with one or more of: a control resource set identification, a downlink shared channel, or a downlink reference signal.

Aspect 22: The method of any of Aspects 16-21, wherein the message includes an indication to apply an uplink and downlink beam pair, of the one or more uplink and downlink beam pairs, to multiple selected cells of the one or more selected cells or multiple physical cell identifications.

Aspect 23: The method of Aspect 22, wherein the indication to apply the uplink and downlink beam pair to the multiple selected cells comprises: an indication of a first selected cell or physical cell identification to use the uplink and downlink beam pair, wherein, based at least in part on pre-configured information at the UE, the first selected cell or physical cell identification is associated with a second selected cell or physical cell identification.

Aspect 24: The method of Aspect 22, wherein the indication to apply the uplink and downlink beam pair to the multiple selected cells comprises: an indication of a first selected cell or physical cell identification and a second selected cell or physical cell identification to use the uplink and downlink beam pair, or an indication that all selected cells or physical cell identifications per cell group are to use the uplink and downlink beam pair.

Aspect 25: The method of Aspect 22, wherein the indication to apply the uplink and downlink beam pair to the multiple selected cells comprises: an indication of a first selected cell or physical cell identification to use the uplink and downlink beam pair, and an indication of a second selected cell or physical cell identification to use another uplink and downlink beam pair.

Aspect 26: The method of any of Aspects 22-25, further comprising: receiving an indication, based at least in part on frequencies of the multiple selected cells, that the UE supports using a single uplink and downlink beam pair for the multiple selected cells that have a same bandwidth part.

Aspect 27: The method of any of Aspects 22-25, further comprising: receiving an indication, based at least in part on frequencies of the multiple selected cells, that the UE supports using a single uplink and downlink beam pair for the multiple selected cells that have different bandwidth parts.

Aspect 28: The method of any of Aspects 16-27, wherein the indication of the one or more uplink and downlink beam pairs for full duplex operation comprises: an indication of at least one downlink and uplink beam pair to use for multiple component carriers of the one or more component carriers.

Aspect 29: The method of Aspect 28, wherein the indication of the at least one downlink and uplink beam pair to use for the multiple component carriers comprises: an indication of a cell group, that includes the multiple component carriers, to use the at least one downlink and uplink beam pair, wherein the cell group is a master cell group or a secondary cell group.

Aspect 30: The method of Aspect 28, wherein the indication of the at least one downlink beam and the at least one uplink beam to use for the multiple component carriers comprises: an indication of a set of aggregated component carriers, that includes the multiple component carriers, to use the uplink and downlink beam pair.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a message that includes:
an indication of one or more selected cells associated with one or more component carriers, and
an indication of one or more uplink and downlink beam pairs for full duplex operation; and
transmit an uplink communication and receive a downlink communication based at least in part on the message.

2. The UE of claim 1, wherein the indication of the one or more selected cells includes one or more of:
a physical cell identification, or
a serving cell identification.

3. The UE of claim 1, wherein the indication of the one or more uplink and downlink beam pairs for full duplex operation comprises:
an indication of at least one downlink and uplink beam pair to use for each of the one or more selected cells.

4. The UE of claim 3, wherein the indication of the at least one downlink and uplink beam pair comprises:
at least one transmission configuration indicator (TCI) state identification that indicates an uplink direction for a first beam and a downlink direction for a second beam.

5. The UE of claim 4, wherein the first beam is associated with one or more of:
an uplink shared channel,
an uplink reference signal, or
a physical random access channel.

6. The UE of claim 4, wherein the second beam is associated with one or more of:
a control resource set identification,
a downlink shared channel, or
a downlink reference signal.

7. The UE of claim 1, wherein the one or more processors, to transmit the uplink communication and receive the downlink communication, are configured to:
apply an uplink and downlink beam pair, of the one or more uplink and downlink beam pairs, to multiple selected cells of the one or more selected cells or multiple physical cell identifications.

8. The UE of claim 7, wherein the one or more processors, to apply the uplink and downlink beam pair to the multiple selected cells, are configured to:
determine that the message indicates a first selected cell or physical cell identification to use the uplink and downlink beam pair,
determine, based at least in part on pre-configured information at the UE, that the first selected cell or physical cell identification is associated with a second selected cell or physical cell identification, and
determine, based at least in part on the first selected cell or physical cell identification being associated with the second selected cell or physical cell identification, to apply the uplink and downlink beam pair to the first selected cell or physical cell identification and the second selected cell or physical cell identification.

9. The UE of claim 7, wherein the one or more processors, to apply the uplink and downlink beam pair to the multiple selected cells, are configured to:
determine that the message indicates a first selected cell or physical cell identification and a second selected cell or physical cell identification to use the uplink and downlink beam pair, or
determine that the message indicates all selected cells or physical cell identifications per cell group are to use the uplink and downlink beam pair.

10. The UE of claim 7, wherein the one or more processors, to apply the uplink and downlink beam pair to the multiple selected cells, are configured to:
determine that the message indicates a first selected cell or physical cell identification to use the uplink and downlink beam pair and indicates a second selected cell or physical cell identification to use another uplink and downlink beam pair.

11. The UE of claim 7, wherein the one or more processors, to apply the uplink and downlink beam pair to the multiple selected cells, are configured to:
determine, based at least in part on frequencies of the multiple selected cells, that the UE supports using the uplink and downlink beam pair for the multiple selected cells that have a same bandwidth part.

12. The UE of claim 1, wherein the one or more processors, to apply the uplink and downlink beam pair to the multiple selected cells, are configured to:
determine, based at least in part on frequencies of the multiple selected cells, that the UE supports using the uplink and downlink beam pair for the multiple selected cells that have different bandwidth parts.

13. The UE of claim 1, wherein the indication of the one or more uplink and downlink beam pairs for full duplex operation comprises:
an indication of at least one downlink and uplink beam pair to use for multiple component carriers of the one or more component carriers.

14. The UE of claim 13, wherein the indication of the at least one downlink and uplink beam pair to use for the multiple component carriers comprises:
an indication of a cell group, that includes the multiple component carriers, to use the at least one downlink and uplink beam pair,
wherein the cell group is a master cell group or a secondary cell group.

15. The UE of claim 13, wherein the indication of the at least one downlink and uplink beam pair to use for the multiple component carriers comprises:
an indication of a set of aggregated component carriers, that includes the multiple component carriers, to use the uplink and downlink beam pair.

16. A base station for wireless communication, comprising:
a memory; and
one or more processors, coupled to the memory, configured to:
transmit, to a user equipment (UE), a message that includes:
an indication of one or more selected cells associated with one or more component carriers, and
an indication of one or more uplink and downlink beam pairs for full duplex operation of the UE; and
receive an uplink communication and transmitting a downlink communication based at least in part on the message.

17. The base station of claim 16, wherein the indication of the one or more uplink and downlink beam pairs for full duplex operation of the UE comprises:
an indication of at least one downlink and uplink beam pair to use for each of the one or more selected cells.

18. The base station of claim 17, wherein the indication of the at least one downlink and uplink beam pair comprises:
at least one transmission configuration indicator (TCI) state identification that indicates an uplink direction for a first beam and a downlink direction for a second beam.

19. The base station of claim 18, wherein the first beam is associated with one or more of:
an uplink shared channel,
an uplink reference signal, or
a physical random access channel.

20. The base station of claim 19, wherein the second beam is associated with one or more of:
a control resource set identification,
a downlink shared channel, or
a downlink reference signal.

21. The base station of claim 16, wherein the message includes an indication to apply an uplink and downlink beam pair, of the one or more uplink and downlink beam pairs, to multiple selected cells of the one or more selected cells or multiple physical cell identifications.

22. The base station of claim 21, wherein the indication to apply the uplink and downlink beam pair to the multiple selected cells comprises:
an indication of a first selected cell or physical cell identification to use the uplink and downlink beam pair,
wherein, based at least in part on pre-configured information at the UE, the first selected cell or physical cell identification is associated with a second selected cell or physical cell identification.

23. The base station of claim 21, wherein the indication to apply the uplink and downlink beam pair to the multiple selected cells comprises:
an indication of a first selected cell or physical cell identification and a second selected cell or physical cell identification to use the uplink and downlink beam pair, or
an indication that all selected cells or physical cell identifications per cell group are to use the uplink and downlink beam pair.

24. The base station of claim 21, wherein the indication to apply the uplink and downlink beam pair to the multiple selected cells comprises:
an indication of a first selected cell or physical cell identification to use the uplink and downlink beam pair, and
an indication of a second selected cell or physical cell identification to use another uplink and downlink beam pair.

25. The base station of claim 21, wherein the one or more processors are further configured to:
receive an indication, based at least in part on frequencies of the multiple selected cells, that the UE supports using a single uplink and downlink beam pair for the multiple selected cells that have a same bandwidth part.

26. The base station of claim 21, wherein the one or more processors are further configured to:
receive an indication, based at least in part on frequencies of the multiple selected cells, that the UE supports using a single uplink and downlink beam pair for the multiple selected cells that have different bandwidth parts.

27. The base station of claim 16, wherein the indication of the one or more uplink and downlink beam pairs for full duplex operation comprises:
an indication of at least one downlink and uplink beam pair to use for multiple component carriers of the one or more component carriers.

28. The base station of claim 27, wherein the indication of the at least one downlink and uplink beam pair to use for the multiple component carriers comprises:
an indication of a cell group, that includes the multiple component carriers, to use the at least one downlink and uplink beam pair,
wherein the cell group is a master cell group or a secondary cell group.

29. A method of wireless communication performed by a user equipment (UE), comprising:
receiving a message that includes:
an indication of one or more selected cells associated with one or more component carriers, and
an indication of one or more uplink and downlink beam pairs for full duplex operation; and
transmitting an uplink communication and receiving a downlink communication based at least in part on the message.

30. A method of wireless communication performed by a base station, comprising:
transmitting, to a user equipment (UE), a message that includes:
an indication of one or more selected cells associated with one or more component carriers, and
an indication of one or more uplink and downlink beam pairs for full duplex operation of the UE; and
receiving an uplink communication and transmitting a downlink communication based at least in part on the message.
